(19) United States
(12) Patent Application Publication
(10) Pub. No.: US 2007/0198245 A1
(43) Pub. Date: Aug. 23, 2007

(54) Apparatus, method, and computer program product for supporting in communication through translation between different languages

(76) Inventors: Satoshi Kamatani, Kanagawa (JP); Tetsuro Chino, Kanagawa (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/525,796

(22) Filed: Sep. 25, 2006

(30) Foreign Application Priority Data
Feb. 20, 2006 (JP) 2006-043181

(51) Int. Cl. G06F 17/28

(52) U.S. Cl. 704/2

(57) ABSTRACT

A communication supporting apparatus includes a rule storage unit that stores an extraction condition for extracting a keyword from a speech and a linking procedure linked with the extraction condition; an input receiving unit that receives an input of a speech; an extracting unit that extracts a keyword from a first speech in a first language based on the extraction condition stored in the rule storage unit; a translation unit that translates the first speech from the first language into a second language; an output unit that outputs the translated first speech; and a linking unit that links the extracted keyword with a second speech spoken in a second language immediately after the output first speech based on the linking procedure made to correspond to the extraction condition used when the keyword is extracted.

### CROSS REFERENCE TO RELATED APPLICATION

This application is based upon and claims the benefit of priority from Japanese Patent Application No. 2006-43181, filed on Feb. 20, 2006, the entire contents of which are incorporated herein by reference.

### BACKGROUND OF THE INVENTION

1. Field of the Invention

The present invention relates to an apparatus, a method, and a computer program product for supporting in communication through a translation between different languages.

2. Description of the Related Art

Recently, there are an increasing number of opportunities of communications between different languages, as the world has become globalized and the computer network techniques have developed. On the other hand, along with the development of natural language processing techniques, machine translation devices for converting texts written in a language such as Japanese into texts in another language such as English have been developed and have already been put into practical use.

Also, along with the development of speech processing techniques, a speech synthesizing device that converts a natural language character string as electronic data into an audio output, and a speech input device that enables inputting of a natural language character string in the form of voice data by converting an input of a speech spoken by a user into a character string, have been developed and have already been put into practical use.

As the above described, natural language processing techniques and speech processing techniques have developed, there is an increasing demand for integration of those techniques to provide communication supporting apparatuses that can support communication between two or more people having different mother tongues from each other.

To realize a reliable speech translation device, it is necessary to prepare a speech recognition device that recognizes various kinds of speeches with high accuracy and a translation device that can accurately translate a wide variety of expressions. However, conventional speech translation devices often fail to correctly recognize or translate a sentence.

For example, when a communication supporting apparatus is to translate “We have a room for 50 dollars a night.” spoken by an English speaker, the communication supporting apparatus may mistakenly recognize it as “We have a room for 15 dollars a night.”, and translate it into Japanese accordingly. In such a case, there is not a grammatical or contextual problem, and therefore, the Japanese speaker speaks the next speech on the assumption that the Japanese translation is correct. As a result, the conversation progresses while there remains a misunderstanding about the room charges as “15 dollars” and “50 dollars”.

To address this problem of a conversation progressing while there is a misunderstanding between the speakers, conventionally, there has been a method of feeding the recognition result of each source language sentence back to the speaker, and a technique of feeding an object language sentence as the speech translation result of a source language sentence back to the source language speaker after translating the object language sentence back into the source language have been suggested so as to determine whether each speech recognition result or each speech translation result matches the intention of the speaker.

For example, Japanese Patent Application Laid-Open (JP-A) No. 2001-222531 discloses the technique of converting the speech translation result of a source language sentence that is input by a speaker of a source language back into a synthesized speech in the source language in a speech translation device, and then feeding the synthesized speech in the source language back to the speaker of the source language.

However, by the method disclosed in JP-A No. 2001-222531, it is necessary for a speaker to present a recognition result or a translation result of his/her speech after confirming and making an amendment to the result. Because of this, conversations are often interrupted, and smooth communications are hindered.

### SUMMARY OF THE INVENTION

According to one aspect of the present invention, a communication supporting apparatus includes a rule storage unit that stores an extraction condition and a linking procedure linked with the extraction condition; an input receiving unit that receives a first speech in a first language and a second speech in a second language; an extracting unit that extracts a keyword from the first speech based on the extraction condition stored in the rule storage unit; a translation unit that translates the first speech from the first language into the second language; an output unit that outputs the translated first speech in the second language; and a linking unit that links the keyword extracted by the extracting unit with the second speech, wherein the input receiving unit receives the second speech spoken immediately after outputting of the translated first speech, the linking unit links the extracted keyword with the second speech based on the linking procedure that is utilized for outputting the extracted keyword linked with the second speech in the second language spoken after the first speech in the first language, and corresponds to the extraction condition, the translation unit further translates the second speech linked with the extracted keyword from the second language into the first language, and the output unit further outputs the extracted keyword in the first language linked with the second speech, and the translated second speech.

According to another aspect of the present invention, a communication method includes receiving a first speech in a first language; extracting a keyword from the first speech in the first language, based on an extraction condition; translating the first speech from the first language into a second language; outputting the translated first speech in the second language; receiving a second speech in the second language, immediately after outputting of the translated first speech in the second language; linking the second speech in the second language, with the extracted keyword in the first language based on a linking procedure correspond to the extraction condition, the linking procedure being utilized for outputting the extracted keyword linked with the second speech in the second language spoken after the first speech in the first language; translating the second speech from the second language into the first language; and outputting the extracted keyword in the first language linked with the second speech, and the translated second speech.

A computer program product according to still another aspect of the present invention causes a computer to perform the method according to the present invention.

### BRIEF DESCRIPTION OF THE DRAWINGS

FIG. 1 is a block diagram showing the construction of a communication supporting apparatus in accordance with a first embodiment of the present invention;

FIG. 2 is an explanatory view showing an example of a data structure of the keyword rules stored in a rule storage unit;

FIG. 3 is an explanatory view showing an example of a data structure of the speech history stored in a speech history storage unit;

FIG. 4 is an explanatory view showing an example of a data structure of the replacement information stored in a replacement information storage unit;

FIG. 5 is a flowchart showing the entire flow of a communication supporting operation in accordance with the first embodiment;

FIG. 6 is a flowchart showing the entire flow of a keyword extracting process in accordance with the first embodiment;

FIG. 7 is an explanatory view showing an example of sentences to be spoken by two speakers to each other;

FIG. 8 is an explanatory view showing an example of the information to be stored in a speech history storage unit;

FIG. 9 is an explanatory view showing an example of an output sentence to be output by the communication supporting apparatus;

FIG. 10 is an explanatory view showing an example of sentences to be spoken by two speakers to each other;

FIG. 11 is an explanatory view showing an example of the information to be stored in the speech history storage unit;

FIG. 12 is an explanatory view showing an example of an output sentence to be output by the communication supporting apparatus;

FIG. 13 is a block diagram showing a structure of a communication supporting apparatus in accordance with a second embodiment;

FIG. 14 is an explanatory view showing an example of a data structure of the adding conditions stored in a adding condition storage unit;

FIG. 15 is an explanatory view showing an example of a data structure of the speech history stored in the speech history storage unit;

FIG. 16 is a flowchart showing the entire flow of a communication supporting operation in accordance with the second embodiment;

FIG. 17 is an explanatory view showing an example of the information to be stored in the speech history storage unit;

FIG. 18 is a block diagram showing the structure of a communication supporting apparatus in accordance with a third embodiment;

FIG. 19 is a flowchart showing the entire flow of a communication supporting operation in accordance with the third embodiment; and

FIG. 20 is an explanatory view showing an example of an output sentence to be output by the communication supporting apparatus.

### DETAILED DESCRIPTION OF THE INVENTION

The following is a detailed description of preferred embodiments of communication supporting apparatuses, communication supporting methods, and communication supporting program product according to the present invention, with reference to the accompanying drawings.

Generally, when the speech partner in conversation cannot prepare a communication supporting apparatus, especially where a communication supporting apparatus owned by a user cannot be shared with the speech partner, it is very difficult for the speech partner to check and correct the recognition result or the translation result of his/her speech.

Also, there is a problem when the speech partner feels awkward about having a stranger sticking a machine toward him/her. Also, being afraid of having the machine stolen, the user of the machine does not feel like sharing it in a positive manner. Also, compared with the user who owns the machine, the probability of the speech partner being not used to handling the machine is very high. Therefore, it is necessary to make the speech partner understand how to use the machine, the contents of each display, and the meaning of each output before starting a dialogue. However, this is a very troublesome task for both the user and the speech partner. Therefore, in the case of a conventional device that corrects each recognition result or translation result, the correction cannot be performed properly even if there is a misunderstanding between the speakers.

A communication supporting apparatus in accordance with a first embodiment of the present invention extracts a keyword from a speech, and outputs a translation result linked with the extracted keyword. Accordingly, the content to be confirmed in each speech can be clearly presented to the speech partner, and the above described problems can be avoided.

In the following description, translating operations between Japanese and English are performed, but the combination of a source language and an object language is not limited to that. Instead, combinations of various other languages may be employed. In the following example, both Japanese and English can be the source language and the object language. For example, when a Japanese speaker speaks, the source language sentence is a Japanese sentence, and the object language sentence is an English sentence. On the other hand, when an English speaker speaks, the source language sentence is an English sentence, and the object language sentence is a Japanese sentence.

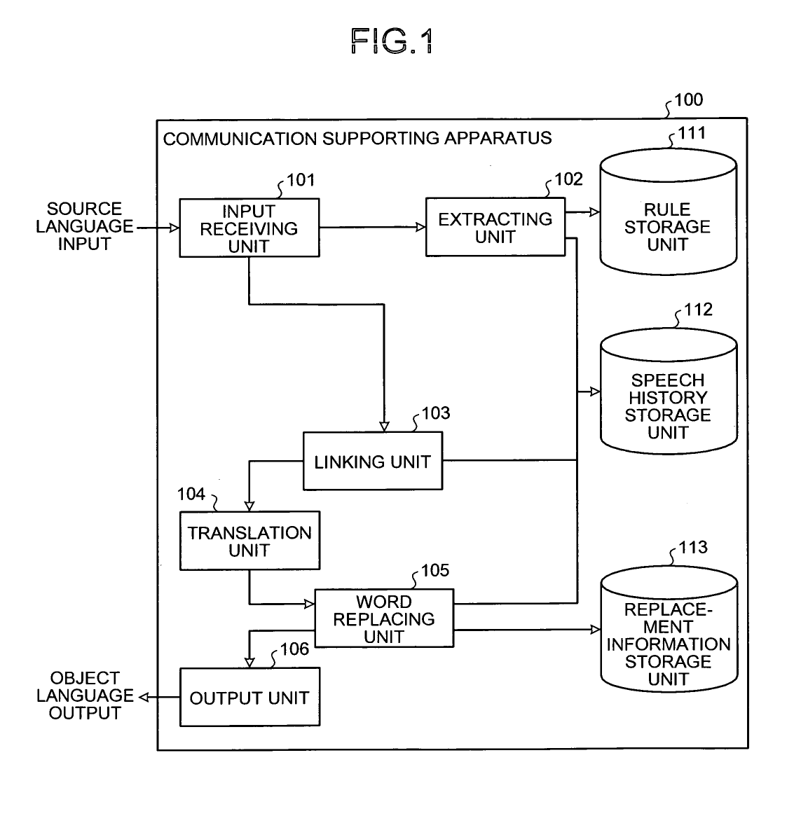

FIG. 1 is a block diagram of the construction of the communication supporting apparatus 100 in accordance with a first embodiment. As shown in FIG. 1, the communication supporting apparatus 100 includes an input receiving unit 101, a extracting unit 102, a linking unit 103, a translation unit 104, a word replacing unit 105, an output unit 106, a rule storage unit 111, a speech history storage unit 112, and a replacement information storage unit 113.

The rule storage unit 111 stores keyword rules which include conditions for extracting a keyword from the contents of a speech and an adding method utilized for outputting the extracted keyword linked with a translation result of the speech.

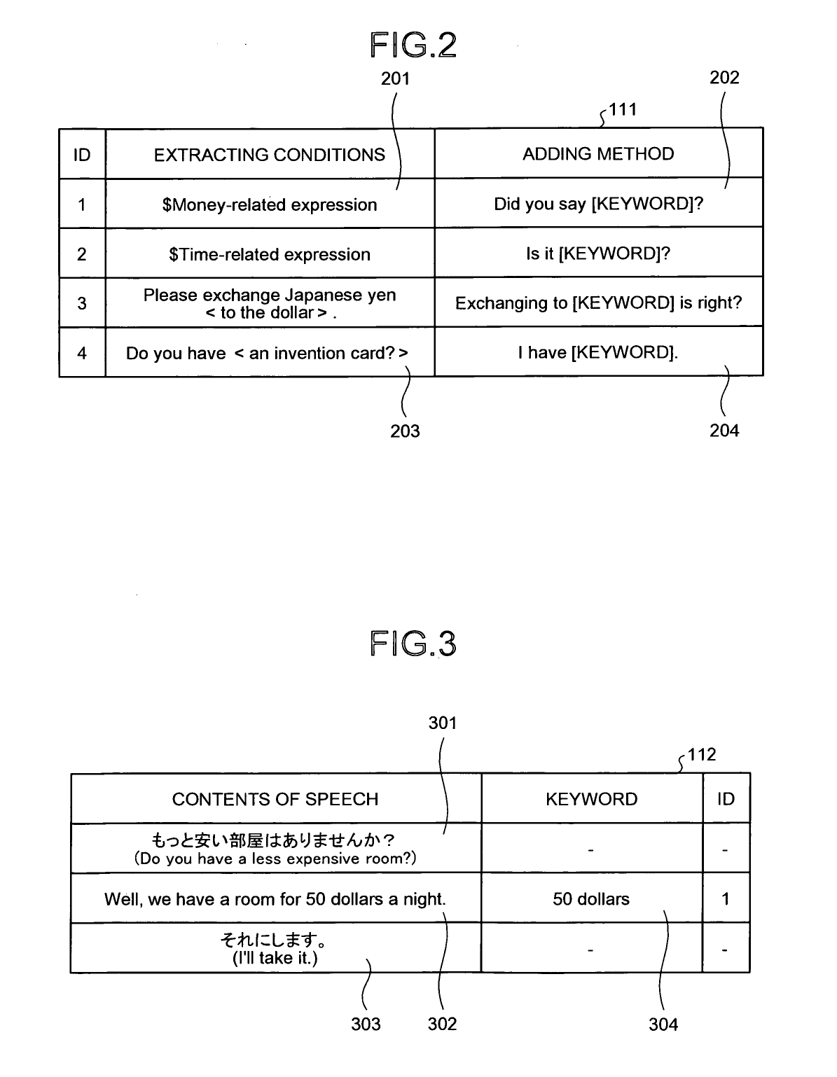

FIG. 2 is an explanatory view showing an example of a data structure of the keyword rules stored in the rule storage unit 111. As shown in FIG. 2, the keyword rules are designed to connect IDs as identifiers for uniquely identifying respective keywords, the extraction conditions for extracting the keywords, and the keyword adding method that specifies the methods of linking extracted keywords with translation results. However, the IDs are merely additional elements that are added for ease of explanation hereafter, and are not essential as long as the rules for each keyword can be distinguished.

The extraction conditions may include a keyword condition for extracting a word or phrase as a keyword containing a predetermined search subject word, and an example sentence condition for extracting a word or phrase as a keyword corresponding to a predetermined keyword contained in an example of a speech.

An extraction condition 201 shown in FIG. 2 is an example of a keyword condition. The extraction condition 201 as a keyword condition specifies the condition for extracting a word or phrase that is a money-related expression as a keyword from a speech. To distinguish from example sentence conditions, the symbol “$” is attached to the top of each of the keyword conditions.

An extraction condition 203 shown in FIG. 2 is an example of an example sentence condition. The extraction condition 203 as an example sentence condition specifies a keyword in an example sentence of a speech in advance. In FIG. 2, each keyword is put in brackets “< >”. In other words, in accordance with the extraction condition 203, when a speech similar to “Do you have an invention card?” is input, the word or phrase corresponding to “<an invention card>” is extracted as a keyword from the input speech.

In the column of “keyword adding method”, sentences each having a fixed part and a variable part are stored. Each fixed part is to be added directly to a translation result, without any modification. A keyword extracted according to an extraction condition is put in each variable part. More specifically, a keyword is put into the variable part of a sentence, and is added to the input speech before output. In FIG. 2, each variable part is shown as [keyword].

For example, a keyword extracting method 202 specifies the method of outputting a translation result having an extracted keyword placed after “Did you say” when the keyword is extracted in accordance with the extraction condition 201.

A keyword extracting method 204 specifies the method of outputting a translation result having an extracted keyword placed after “I have” when the keyword is extracted in accordance with the extraction condition 203.

The speech history storage unit 112 stores the history of speeches spoken by both speakers via the communication supporting apparatus 100. The speech history storage unit 112 is referred to when a keyword to be added to the latest speech is extracted from a past speech.

FIG. 3 is an explanatory view showing an example of the data structure of the speech history stored in the speech history storage unit 112. As shown in FIG. 3, the speech history includes the contents of speeches in the source language and the object language, keywords extracted from the speeches, and IDs of the keyword rules adopted when the keyword are extracted. The speech contents, the extracted keywords, and the ID are linked with one another.

In FIG. 3, each one speech is stored as one record in a tabular form, and a new speech is added as a new record at the lowermost row. If a keyword is not extracted from a speech, the corresponding keyword and ID sections remain blank.

For example, a speech content 301 indicates a speech spoken by a Japanese speaker, and the corresponding keyword and ID sections remain blank, as there is not a keyword extracted from the speech content 301. A speech content 302 indicates a speech spoken by an English speaker in response to the speech content 301, and “50 dollars” is extracted as a keyword 304 from the speech content 302. A speech content 303 indicates a speech spoken by the Japanese speaker in response to the speech content 302, and a keyword is not extracted from the speech content 303.

The replacement information storage unit 113 stores the information as to replacement words (replacement information). Each of the replacement words is a word or phrase that has the same meaning as a arbitrary phrase but is expressed in a different form from the arbitrary phrase in the same language. The replacement information storage unit 113 does not add a keyword extracted from a past speech directly to a translation result, but replaces the extracted keyword with another word or phrase. Therefore, a misunderstanding between the speakers can be avoided.

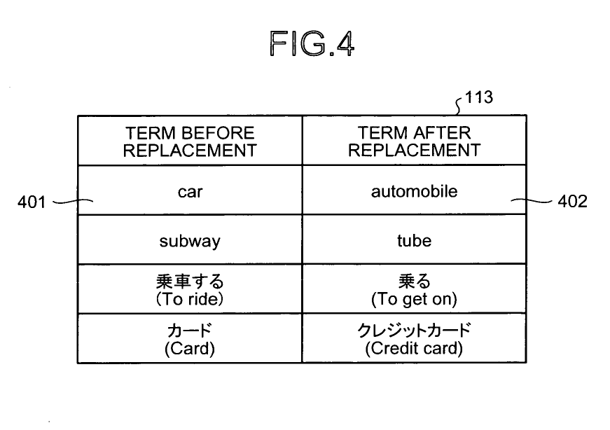

FIG. 4 is an explanatory view showing an example of the data structure of the replacement information stored in the replacement information storage unit 113. As shown in FIG. 4, the replacement information includes terms to be replaced before replacement and terms as replacement results after replacement. The terms to be replaced are made to correspond to the terms as the replacement results.

For example, a term before replacement 401 “car” shown in FIG. 4 is replaced with a term after replacement 402 “automobile”.

The rule storage unit 111, the speech history storage unit 112, and the replacement information storage unit 113 can be formed with recording media such as a HDD (Hard Disk Drive), an optical disk, a memory card, and a RAM (Random Access Memory) that are generally used.

The input receiving unit 101 receives an input of text data in a source language that is a recognition result of a speech recognizing operation performed for a voice input from a user. Here, the input receiving unit 101 may be used together with or may be replaced with a generally used device such as a keyboard, a pointing device, or a handwritten character recognition device.

The speech recognizing operation may be performed by any of the generally used speech recognition methods utilizing LPC analysis, a hidden Markov model (HMM), dynamic programming, a neural network, a N-gram language model, or the like.

The extracting unit 102 refers to the extraction conditions stored in the rule storage unit 111, to extract a keyword from an input speech.

More specifically, the extracting unit 102 detects a word or phrase that satisfies an extraction condition as a keyword condition from an input speech, and extracts the detected word or phrase as a keyword. The extracting unit 102 also detects the same example sentence as the input speech or a similar example sentence to the input speech from the extraction conditions as example sentence conditions, and extracts, as the keyword in the input speech, the word or phrase corresponding to the keyword in the detected example sentence.

To detect a word or phrase that satisfies an extraction condition as a keyword condition is to detect not only the same word or phrase as the word or phrase defined by the keyword condition but also a similar word or phrase. A similar word or phrase may have the same meaning as the word or phrase defined by the keyword condition or has higher structural or surface similarity than a predetermined value.

Here, a conventional natural language analyzing process such as syntax analysis and semantic analysis can be carried out. To calculate the maximum structural or surface similarity, various conventional techniques such as dynamic programming can be utilized.

When a similar example sentence is to be detected using the example sentence conditions, various conventional similar sentences searching technique such as the method disclosed in Japanese Patent No. 3135221 can be utilized.

If there are two or more extraction conditions that can be applied to one speech, the extracting unit 102 chooses the extraction condition with the highest predetermined priority. For example, since priority is given to each example sentence condition over any keyword conditions, the priority of each example sentence condition is set higher than that of each keyword condition. Also, it is possible to choose an example sentence condition corresponding to an example sentence having higher similarity to the contents of the speech among example sentence conditions. It is also possible to give priority to'an extraction condition that has been registered earlier or an extraction condition with a smaller ID. Alternatively, all the extraction conditions or a predetermined number of extraction conditions with the higher priorities may be collectively applied so as to extract several keywords at once.

The linking unit 103 adds a keyword extracted from a speech of the speech partner to the input speech by a keyword adding method made to correspond to the extraction condition used by the extracting unit 102 at the time of keyword extraction.

For example, when a money-related expression is extracted as a keyword in accordance with the extraction condition 201 shown in FIG. 2, the corresponding keyword adding method 202 is applied, so that a sentence having the money-related expression as the extracted keyword put after “Did you say” is added to the input speech and is then output.

The linking unit 103 may add a sentence already translated into the object language to an input speech, and then output the sentence. In such a case, sentences written in both the source language and the object language are stored in the keyword adding method column of the rule storage unit 111, and a keyword is put into a sentence written in the same language as the language to be output. In this manner, a sentence that has already been translated into the object language can be added to the sentence to be output.

The translation unit 104 translates a speech having a keyword added thereto into an object language sentence. In the translation process performed by translation unit 104, various conventional methods used in machine translation systems, such as a transfer method, an example-based method, a statistics-based method, or an intermediate language method, may be applied in the translating process to be carried out by the translation unit 104.

If the linking unit 103 is designed to add a sentence having a translated keyword to each output, the translation unit 104 translates only input speeches.

The word replacing unit 105 refers to the replacement information stored in the replacement information storage unit 113, and replaces the translated keyword added by the linking unit 103 with a replacement word.

The word replacing unit 105 may be designed to replace the keyword linked to a speech previously to be translated by the translation unit 104 with a replacement word. In this case, the translation unit 104 translates the speech having the replacement word in place of the keyword into an object language sentence.

The output unit 106 outputs a replacement word in place of a keyword replaced by the word replacing unit 105, and a result of a translation performed by the translation unit 104. Here, the translation result is output as synthesized voice data in English, which is the object language. Various commonly used methods such as speech element editing voice synthesis, formant voice synthesis, speech-corpus-based voice synthesis, and text-to-speech synthesis may be utilized in the speech synthesizing operation to be performed by the output unit 106.

The speech output by the output unit 106 may be a text output in the object language on a display device that displays a text on a screen, or various other outputs such as an output of an object language sentence through text printing by a printer or the like. The speech output may be performed by the output unit 106 in cooperation with a display unit, or may be performed by a display unit instead.

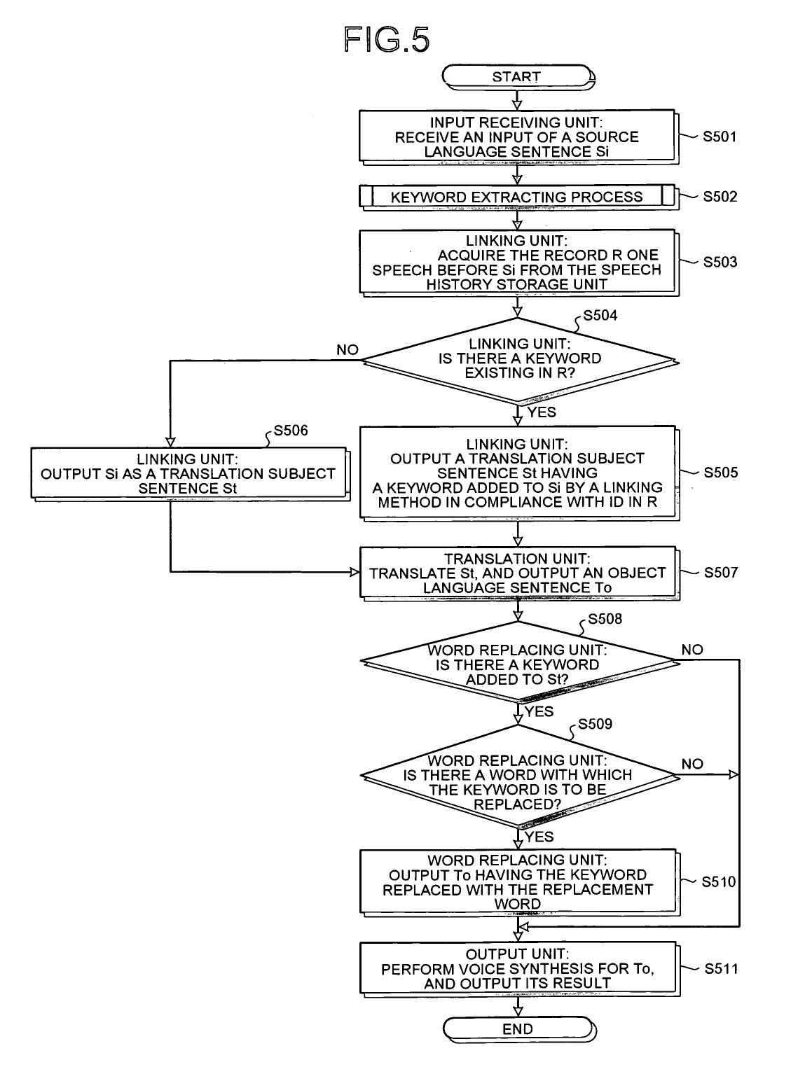

Next, a communication supporting operation to be performed by the communication supporting apparatus 100 in accordance with the first embodiment with the above described construction is described. FIG. 5 is a flowchart of the entire communication supporting operation in accordance with the first embodiment.

First, the input receiving unit 101 receives an input of a sentence in a source language Si (step S501). More specifically, the input receiving unit 101 recognizes a speech in the source language, and receives an input of the source language sentence Si as text data in the source language that is the result of the speech recognition.

Next, the extracting unit 102 performs a keyword extracting process to extract a keyword from the received source language sentence Si (step S502). The keyword extracting process will be described later in detail.

The keyword extracting process of step S502 is carried out to extract a keyword from the latest input speech, and the extracted keyword is to be added to speeches that will be input later. However, the keywords to be added by the linking unit 103 in step S503 and the later steps are not the keyword extracted from the latest speech in step S502, but are keywords extracted from the past speeches.

Next, the linking unit 103 acquires a record R of the speech that is one speech earlier than the latest speech, from the speech history storage unit 112 (step S503). The linking unit 103 then determines whether there is a keyword in the record R (step S504).

If there is a keyword (“YES” in step S504), the linking unit 103 adds the keyword to the source language sentence Si by the keyword adding method in the record R, and outputs the source language sentence Si with the added keyword as a translation subject sentence St (step S505).

If there is not a keyword (“NO” in step S504), the linking unit 103 outputs the source language sentence Si as the translation subject sentence St (step S506).

The translation unit 104 then translates the translation subject sentence St to output an object language sentence To (step S507). If the translation by the translation unit 104 is of a transfer method, various dictionaries (not shown) used in natural language processing, such as morphologic analysis, syntax analysis, and semantic analysis, are referred to. If the translation is of an example-based method, a dictionary or the like (not shown) storing example sentences in both the source language and the object language is referred to.

Next, the word replacing unit 105 determines whether a keyword has been added to the translation subject sentence St (step S508). If a keyword has been added (“YES” in step S508), the word replacing unit 105 searches the replacement information storage unit 113, and determines whether a word with which the keyword is to be replaced exists (step S509).

If there is a replacement word (“YES” in step S509), the word replacing unit 105 outputs an object language sentence To having the detected replacement word in place of the keyword (step S510).

If there is not a keyword added to the translation subject sentence St in step S508 (“NO” in step S508), or if there is not a word with which the keyword is to be replaced (“NO” in step S509), or after the word replacing unit 105 outputs the object language sentence To in step S510, the output unit 106 performs voice synthesis in the object language for the object language sentence To, and outputs its result (step S511).

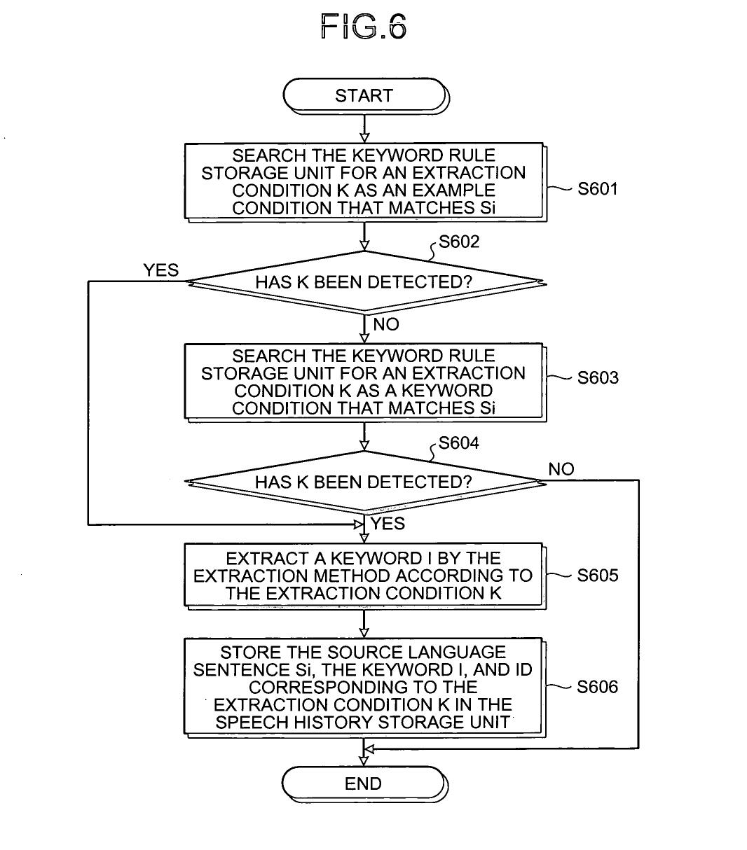

Next, the keyword extracting process of step S502 is described in detail. FIG. 6 is a flowchart showing the entire flow of the keyword extracting process in accordance with the first embodiment.

First, the extracting unit 102 searches the rule storage unit 111 for an extraction condition K as an example condition that matches the source language sentence Si (step S601). More specifically, using a similar example searching technique, the extracting unit 102 searches for an example condition that describes the same example sentence as the source language sentence Si or a similar example sentence to the source language sentence Si.

The extracting unit 102 then determines whether the extraction condition K has been detected (step S602). If the extracting unit 102 determines that the extraction condition K has not been detected (“NO” in step S602), the extracting unit 102 searches the rule storage unit 111 for an extraction condition K as a keyword condition that matches the source language sentence Si (step S603).

More specifically, the extracting unit 102 determines whether the word described in the keyword condition is contained in the source language sentence Si, and, if it includes, the extracting unit 102 acquires the keyword condition as the extraction condition K that matches the source language sentence Si.

The extracting unit 102 then determines whether the keyword condition K has been detected (step S604). If the extracting unit 102 determines that the keyword condition K has not been detected (“NO” in step S604), the extracting unit 102 determines that the source language sentence Si does not include a keyword, and ends the keyword extracting process.

If the extraction condition K as an example condition is detected in step S602 (“YES” in step S602), or if the extraction condition K as a keyword condition is detected in step S604 (“YES” in step S604), the extracting unit 102 extracts a keyword I in accordance with the extraction condition K (step S605).

For example, when a source language sentence Si “Do you have any cards?” is input, an extraction condition 203 as an example condition shown in FIG. 2 is detected as the extraction condition K (step S601). Further, “cards” is extracted as the keyword I from the source language sentence Si in accordance with “<an invention card>” in the extraction condition 203 (step S605).

The extracting unit 102 then stores the source language sentence Si, the keyword I, and the ID corresponding to the extraction condition K in the speech history storage unit 112 (step S606), and ends the keyword extracting process.

Through the above described procedures, the keyword extracted in step S605 is added to the source language sentence Si in step S505, and the source language sentence Si with the added keyword is translated in step S507 and is output to the other side in conversation in step S511. Since the process for determining whether the recognized result is correct is not included, the conversation is not interrupted, and smooth communication can be maintained. Furthermore, since the translation result output to the other side in the conversation has the keyword added thereto, the possibility of the conversation progressing while there is a misunderstanding between the two sides can be decreased.

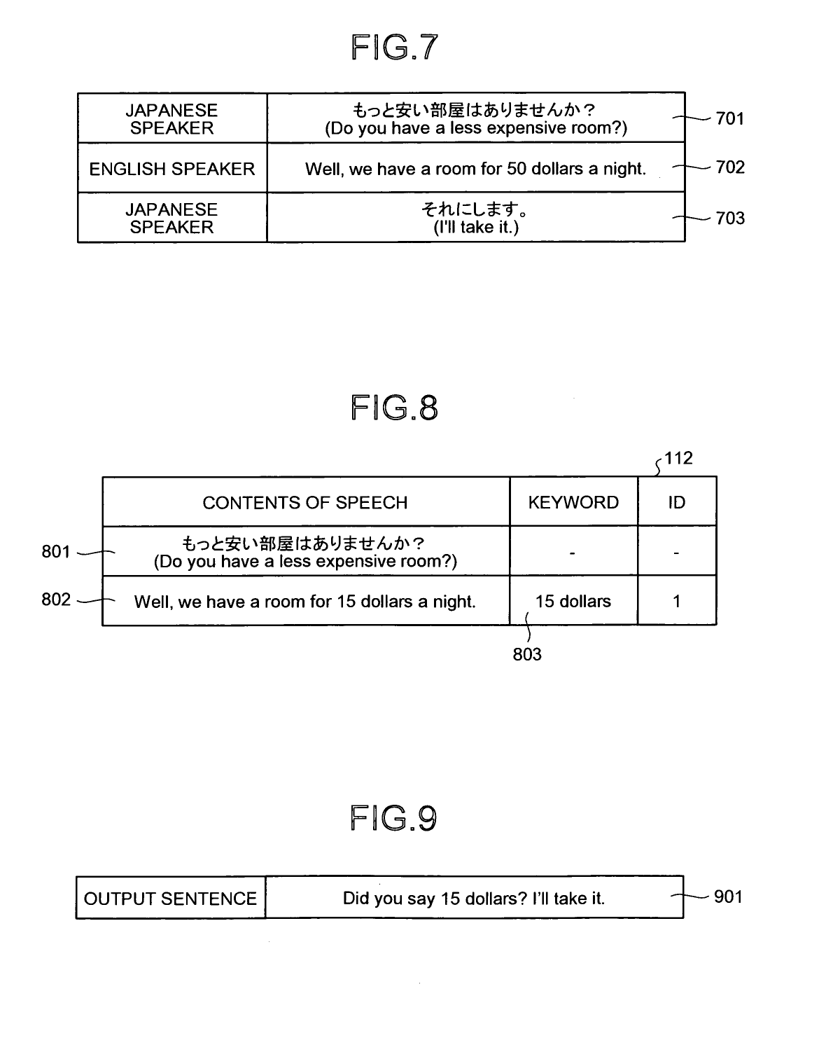

Next, a specific example of the communication supporting operation in accordance with the first embodiment is described. FIG. 7 is an explanatory view showing an example of sentences spoken in conversation. FIG. 8 is an explanatory view showing an example of information to be stored in the speech history storage unit 112 when the sentences shown in FIG. 7 are spoken. FIG. 9 is an explanatory view showing an example of a sentence to be output by the communication supporting apparatus 100.

The following explanation is made on the assumption that speeches are to be made by a Japanese speaker, a Japanese sentence 701 meaning “Do you have a less expensive room?” shown in FIG. 7 has already been input, and the record shown in a speech content 801 shown in FIG. 8 has already been stored in the speech history storage unit 112. Also, the information shown in FIG. 2 and the information shown in FIG. 4 are stored in the rule storage unit 111 and the replacement information storage unit 113, respectively.

When an English speaker speaks an English sentence 702 “Well, we have a room for 50 dollars a night.” under such conditions, the input receiving unit 101 receives an input of the English sentence 702 as a source language sentence Si.

In this case, it is assumed that the input receiving unit 101 mistakenly recognizes the input speech as “Well, we have a room for 15 dollars a night.”, and outputs it as the source language sentence Si (step S501).

The keyword extracting process is then carried out (step S502). First, the extracting unit 102 refers to the rule storage unit 111 to detect an example condition similar to the source language sentence Si (step S601). Since there is not a similar example sentence in the rule storage unit 111 as shown in FIG. 2 (“NO” in step S602), the extracting unit 102 then searches for a keyword condition that matches the source language sentence Si (step S603).

As a money-related expression “15 dollars” is contained in the source language sentence Si in this example, the extraction condition 201 as the keyword condition in FIG. 2 is searched, and is extracted “15 dollars” as a keyword I (step S605).

Accordingly, the source language sentence Si “Well, we have a room for 15 dollars a night.”, the keyword I “15 dollars”, and the ID “1” of the matched extraction condition are stored in the speech history storage unit 112 (step S606). At this point, the contents of the speech history storage unit 112 become as shown in FIG. 8.

The linking unit 103 then refers to the speech history storage unit 112 to acquire the record R corresponding to the speech content 801 shown in FIG. 8 as the record that is one speech before the source language sentence Si (step S503). Since the acquired record R does not contain the keyword (“NO” in step S504), the source language sentence Si is output as a translation subject sentence St (step S506).

The translation unit 104 then translates the translation subject sentence St to output an object language sentence To (step S507). Since there is not an added keyword (“NO” in step S508), the output unit 106 performs speech synthesis for the object language sentence To, and outputs the speech (step S511). As a result, a Japanese sentence translated from the source language sentence Si “Well, we have a room for 15 dollars a night.” is output.

Subsequently, the Japanese speaker speaks a Japanese sentence 703. In this case, the input receiving unit 101 receives an input of the Japanese sentence 703 as a source language sentence Si.

Here, it is assumed that the input receiving unit 101 recognizes the input speech correctly, and outputs it as the source language sentence Si (step S501).

The keyword extracting process is then carried out (step S502). First, the extracting unit 102 refers to the rule storage unit 111 to search an example condition similar to the source language sentence Si (step S601). Since there is not a similar example sentence in the rule storage unit 111 as shown in FIG. 2 (“NO” in step S602), the extracting unit 102 then searches for a keyword condition that matches the source language sentence Si (step S603).

As there is not a matching keyword condition detected from the rule storage unit 111 as shown in FIG. 2 (“NO” in step S604), only the source language sentence Si is stored in the speech history storage unit 112 (step S606).

The linking unit 103 then refers to the speech history storage unit 112 to acquire the record R corresponding to the speech content 802 “Well, we have a room for 15 dollars a night.” shown in FIG. 8 as the record that is one speech before the source language sentence Si (step S503). Since the acquired record R contains the keyword (“YES” in step S504), a translation subject sentence St having a sentence “Did you say 15 dollars?” added to the source language sentence Si is output by the keyword adding method corresponding to the ID “1” in the record R (step S505).

The translation unit 104 then translates the translation subject sentence St to output an object language sentence To (step S507). Since the added sentence “Did you say 15 dollars?” is already written in English, which is the object language, the translation unit 104 does not need to translate the added sentence.

Also, as the keyword has been added to the translation subject sentence St (“YES” in step S508), the replacement word searching process is carried out (step S509). Since the keyword does not exist in the replacement information storage unit 113 shown in FIG. 4 (“NO” in step S509), the output unit 106 performs speech synthesis for the object language sentence To, and outputs the speech (step S511). As a result, an output sentence 901 “Did you say 15 dollars? I'll take it.” shown in FIG. 9 is output as an English sentence translated from the source language sentence Si having the keyword added thereto.

Through the above described operation, the translation result of an important phrase (“15 dollars”) is added to the translation result of the speech of the Japanese speaker, even if the important phrase is mistakenly recognized as in the case where the sentence “Well, I have a room for 50 dollars a night.” spoken by the English speaker is recognized as “Well, I have a room for 15 dollars a night.”

In this manner, the recognition result of the keyword is presented so that the other side of the conversation can confirm the result, and the recognition result can also be presented in synchronization with the timing of translating each speech of the user. Therefore, the operation contents can be confirmed without adversely affecting the communication between the speakers or on the operation between the user and the communication supporting apparatus 100.

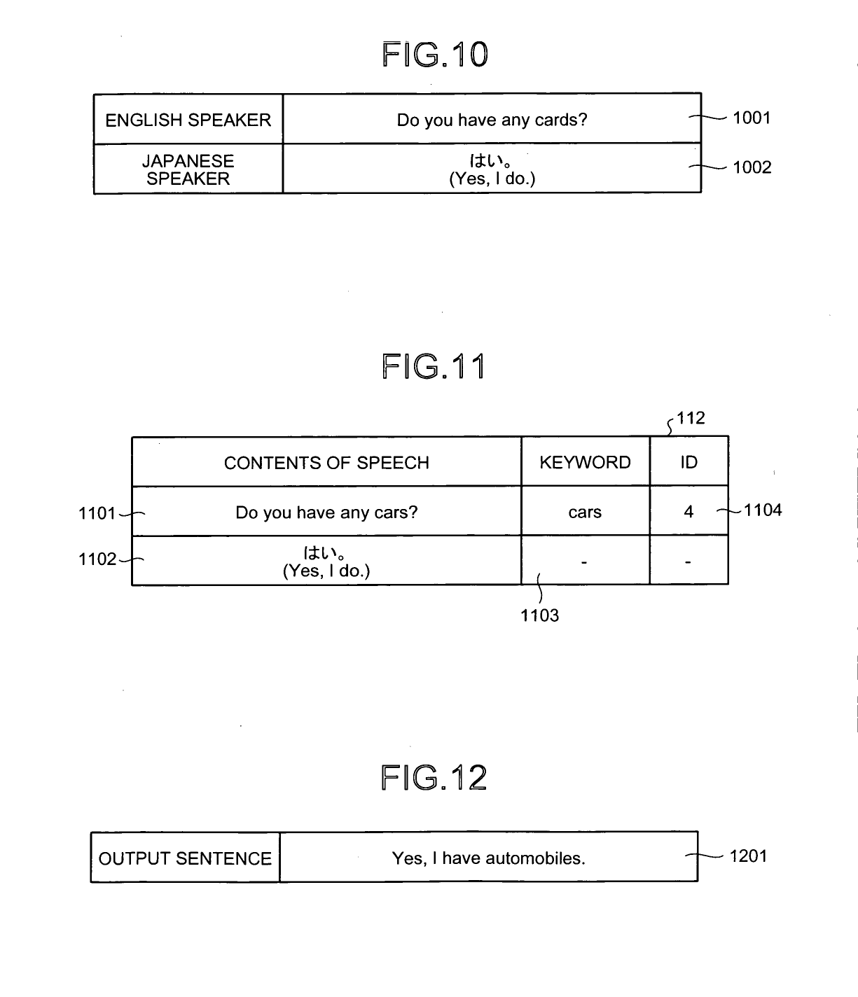

Next, another specific example of the communication supporting operation in accordance with the first embodiment is described. FIG. 10 is an explanatory view showing an example of sentences to be spoken by the speakers to each other. FIG. 11 is an explanatory view showing an example of the information to be stored in the speech history storage unit 112 when the sentences shown in FIG. 10 are spoken. FIG. 12 is an explanatory view showing an example of an output sentence to be output by the communication supporting apparatus 100.

In the example case described below, it is assumed that no speech contents are stored in the speech history storage unit 112 that remains empty, and also the information shown in FIG. 2 and the information shown in FIG. 4 are stored in the rule storage unit 111 and the replacement information storage unit 113, respectively.

When the English speaker speaks an English sentence 1001 “Do you have any cards?” shown in FIG. 10 in this situation, the input receiving unit 101 receives an input of the English sentence 1001 as a source language sentence Si.

In this example, it is assumed that the input receiving unit 101 mistakenly recognizes the input speech as “Do you have any cars?”, and output it as the source language sentence Si (step S501).

The keyword extracting process is then carried out (step S502). First, the extracting unit 102 refers to the rule storage unit 111, to search an example condition similar to the source language sentence Si (step S601). In this example, the extraction condition 203 as an example condition is searched from the rule storage unit 111 as shown in FIG. 2 (“YES” in step S602).

Also, the term “cars” corresponding to the keyword in the extraction condition 203 is extracted as a keyword I (step S605).

Accordingly, the source language sentence Si “Do you have any cars?”, the keyword I “cars”, and the ID “4” of the matched extraction condition are stored in the speech history storage unit 112 (step S606). At this point, the contents stored in the speech history storage unit 112 include an English sentence 1101, a keyword 1103, and an ID 1104 shown in FIG. 11.

The linking unit 103 then refers to the speech history storage unit 112, but fails to acquire a keyword, since a record that is one speech before the source language sentence Si does not exist (“NO” in step S504). Therefore, the source language sentence Si is output as a translation subject sentence St (step S506).

The translation unit 104 then translates the translation subject sentence St to output an object language sentence To (step S507). Since there is not an added keyword (“NO” in step S508), the output unit 106 performs speech synthesis for the object language sentence To, and outputs the speech (step S511). As a result, a Japanese sentence translated from the source language sentence Si (“Do you have any cars?”) is output.

After that, the Japanese speaker speaks a Japanese sentence 1002. In this case, the input receiving unit 101 receives an input of the Japanese sentence 1002 as a source language sentence Si.

Here, it is assumed that the input receiving unit 101 recognizes the input speech correctly, and outputs it as the source language sentence Si (step S501).

The keyword extracting process is then carried out (step S502). First, the extracting unit 102 refers to the rule storage unit 111, to search an example condition similar to the source language sentence Si (step S601). Since there is no similar example sentence in the rule storage unit 111 as shown in FIG. 2 (“NO” in step S602), the extracting unit 102 then searches for a keyword condition that matches the source language sentence Si (step S603).

As there is no matching keyword condition detected from the rule storage unit 111 as shown in FIG. 2 (“NO” in step S604), only the source language sentence Si is stored in the speech history storage unit 112 (step S606). At this point, the contents stored in the speech history storage unit 112 include the English sentence 1101 and a Japanese sentence 1102, as shown in FIG. 11.

The linking unit 103 then refers to the speech history storage unit 112, to acquire the record R corresponding to the English sentence 1101 “Do you have any cars?” shown in FIG. 11 as the record that is one speech before the source language sentence Si (step S503). Since the acquired record R contains the keyword (“YES” in step S504), a translation subject sentence St having a sentence “I have cars.” added to the source language sentence Si is output according to the keyword adding method corresponding to the ID “4” in the record R (step S505).

The translation unit 104 then translates the translation subject sentence St, to output an object language sentence To (step S507). Since the added sentence “I have cars.” is written in English, which is already the object language, the translation unit 104 does not need to translate the added sentence.

Also, as the keyword has been added to the translation subject sentence St (“YES” in step S508), the replacement word searching process is carried out (step S509). In this example, since the word “automobiles” exists as the replacement word for the keyword “cars” in the replacement information storage unit 113 shown in FIG. 4, (“YES” in step S509), the keyword in the object language sentence To is replaced with the replacement word (step S510).

The output unit 106 then performs speech synthesis for the object language sentence To, and outputs the speech (step S511). As a result, an output sentence 1201 “Yes, I have automobiles.” shown in FIG. 12 is output as an English sentence that is translated from the source language sentence Si and has the replacement word in place of the keyword.

Through the operation as described above, the translation result of a keyword replaced with a replacement word (“automobiles”) is added to the translation result of the speech of the Japanese speaker, even if an important sentence is mistakenly recognized as in the case where the sentence “Do you have cards?” spoken by the English speaker is recognized as “Do you have cars?”

In this manner, the keyword is not only repeated but also is translated into a different term from the term used in the speech spoken by the speech partner. Thus, the confirmation of the recognition result of each speech content can be more effectively performed.

Alternatively, it is possible to inquire of the user whether a keyword may be added, and then control whether the keyword should be added to the sentence to be output. Also, the output unit 106 may be designed to output each keyword added by the linking unit 103 and each keyword replaced by the word replacing unit 105 in a manner different from the other parts.

For example, when an output after speech synthesis is to be made, the attributes linked with the speech, such as the volume and voice quality, may be changed. Alternatively, when an output is made onto a screen or a printer, the added part may be underlined, or the font size, the style, or the font color of the added part may be changed. Accordingly, the speech partner in conversation can promptly recognize which one is the keyword.

In this manner, the communication supporting apparatus in accordance with the first embodiment extracts a keyword in a conversation, and presents the translation result linked with the keyword to the speech partner. Therefore, the communication supporting apparatus can facilitate the speech partner to confirm the keyword in the conversation. Also, by translating the extracted keyword into an expression different from the expression used in the speech spoken by the speech partner, the communication supporting apparatus can make the user correctly recognize the speech of the speech partner, and make the user more accurately confirm the translation. Thus, smooth conversation is not interrupted, and the conversation is prevented from progressing while there is a misunderstanding between the two sides of the conversation.

A communication supporting apparatus in accordance with a second embodiment analyzes the intention of each speech, and performs a keyword adding process only if the analysis result matches a predetermined intention of speech.

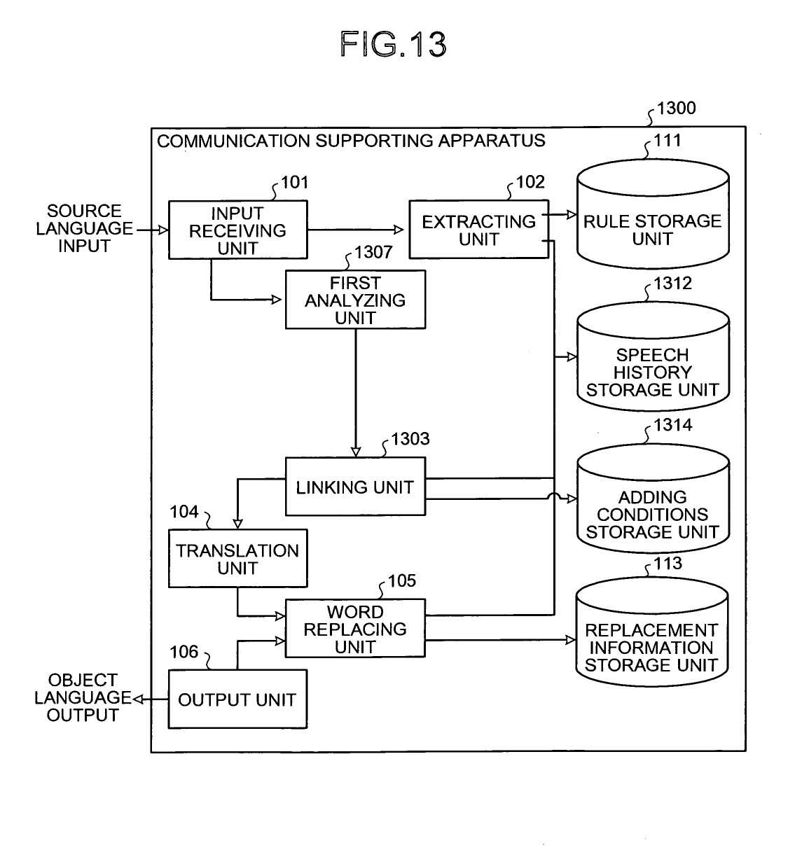

FIG. 13 is a block diagram showing the structure of a communication supporting apparatus 1300 in accordance with the second embodiment. As shown in FIG. 13, the communication supporting apparatus 1300 includes an input receiving unit 101, a extracting unit 102, a keyword adding unit 1303, a translation unit 104, a word replacing unit 105, an output unit 106, a first analyzing unit 1307, a rule storage unit 111, a speech history storage unit 1312, a replacement information storage unit 113, and an adding condition storage unit 1314.

The second embodiment differs from the first embodiment in that the first analyzing unit 1307 and the adding condition storage unit 1314 are added, and the function of the keyword adding unit 1303 is different from that of the linking unit 103 of the first embodiment. Also, a data structure of the speech history storage unit 1312 is different from that of the first embodiment. The other constructions and functions of the second embodiment are the same as those of the communication supporting apparatus 100 of the first embodiment shown in the block diagram of FIG. 1. The same components as those of the first embodiment are denoted by the same reference numerals as those of the first embodiment, and an explanation thereof is omitted herein.

The adding condition storage unit 1314 stores adding conditions which are conditions for carrying out keyword adding processes, and is referred to when whether an adding process can be carried out is determined in accordance with the intention of the subject speech.

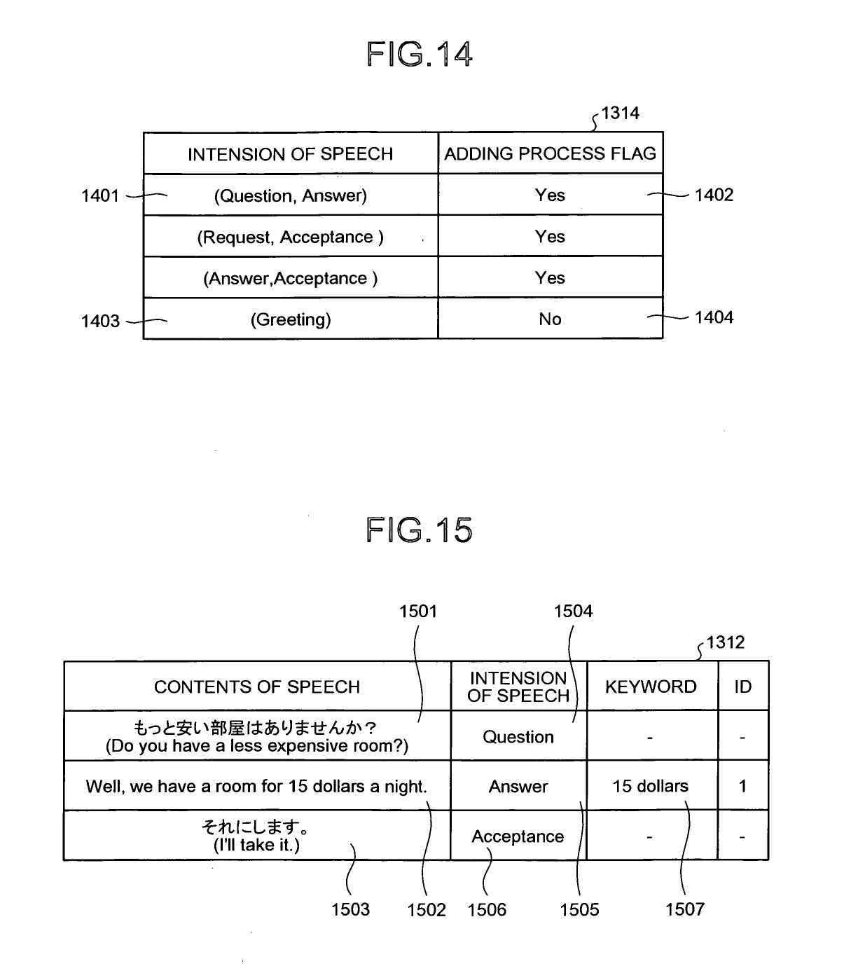

FIG. 14 is an explanatory view showing an example of the data structure of the adding conditions stored in the adding condition storage unit 1314. As shown in FIG. 14, each of the adding conditions has a speech intention linked with an adding process flag indicating whether an adding process should be carried out.

In the “speech intention” column, the intentions of speeches analyzed by the first analyzing unit 1307 (described later) or combinations of speech intentions are designated. In FIG. 14, for example, a speech intention 1401 shows a combination of speech intentions when two speeches have intentions of a “question” and an “answer”, respectively. A speech intention 1403 indicates a speech intention when one speech has a speech intention of a “greeting”.

In the adding process flag column, “YES” as a flag for carrying out an adding process or “NO” as a flag for not carrying out an adding process is designated. In FIG. 14, for example, an adding process flag 1402 “YES” indicates that an adding process is to be carried out when the speech intention is a combination of a “question” and an “answer”. An adding process flag 1404 “NO” indicates that an adding process is not to be carried out when the speech intention is a “greeting”.

Alternatively, the adding process flag column of the adding conditions may be eliminated from the adding condition storage unit 1314, and only the speech intentions with which adding processes are to be carried out may be designated. In this case, adding operations are not to be carried out with the speech intentions that are not stored in the adding condition storage unit 1314.

The speech history storage unit 1312 differs from the speech history storage unit 112 of the first embodiment in that each stored speech content is linked with a speech intention.

FIG. 15 is an explanatory view showing an example of a data structure of the speech history stored in the speech history storage unit 1312. As shown in FIG. 15, the speech history has speech contents, keywords, speech intentions, and keyword rule IDs linked to one another.

In the speech intention column, the speech intention of each speech analyzed by the first analyzing unit 1307 (described later) is stored. For example, the speech intentions include questions, answers, acceptances, requests, and greetings.

For example, a speech content 1501 in FIG. 15 is made to correspond to a speech intention 1504 of “question”. A speech content 1502 is made to correspond to a speech intention 1505 of “answer”. A speech content 1503 is linked with a speech intention 1506 of “acceptance”. A keyword 1507 is extracted as a keyword from the speech content 1502.

The first analyzing unit 1307 carries out a natural language analyzing process such as morphologic analysis, syntax analysis, dependency parsing, semantic analysis, and context analysis for each source language sentence received through the input receiving unit 101, referring to vocabulary information and grammatical rules. By doing so, the first analyzing unit 1307 outputs a source language interpretation which is an interpretation of the contents representing the source language sentence.

The first analyzing unit 1307 also refers to the conversation history stored in the speech history storage unit 1312, analyzes the speech intention of the source language sentence currently input as well as the structure of the conversation, and outputs the analysis result.

For example, when a speech “It's in front of the post office.” is input in response to a speech “Where is the bus stop?” having the speech intention of “question”, the first analyzing unit 1307 analyzes the speech as a speech having the speech intention of “answer” to the previous speech.

Here, the natural language analyzing process by the first analyzing unit 1307 may utilize various well-known, widely-prevailing techniques, such as morphologic analysis utilizing the A*algorithm, syntax analysis utilizing an early method, a chart method, or a generalizing LR method, context analysis or discourse analysis based on Shank's scripts or a discourse display theory.

Dictionaries for natural language processing that store morphologic information, syntax information, and semantic information are recorded on a general-purpose storage media such as a HDD, an optical disk, a memory card, or RAM. The dictionaries are referred to when a natural language analyzing process is carried out.

The keyword adding unit 1303 differs from the linking unit 103 according to the first embodiment in that the keyword adding unit 1303 determines whether a keyword adding process should be carried out for each speech received through the input receiving unit 101 while referring to the speech history storage unit 1312.

More specifically, the keyword adding unit 1303 acquires the speech intention of the latest speech and the speech intention one speech before the latest speech from the speech history storage unit 1312, and determines whether the acquired combination of speech intentions or the acquired speech intention of the latest speech matches one of the conditions defined in the speech intention column of the adding condition storage unit 1314. If there is a matching speech intention in the speech intention column, the keyword adding unit 1303 acquires the corresponding adding process flag from the adding condition storage unit 1314, and determines whether an adding process should be carried out.

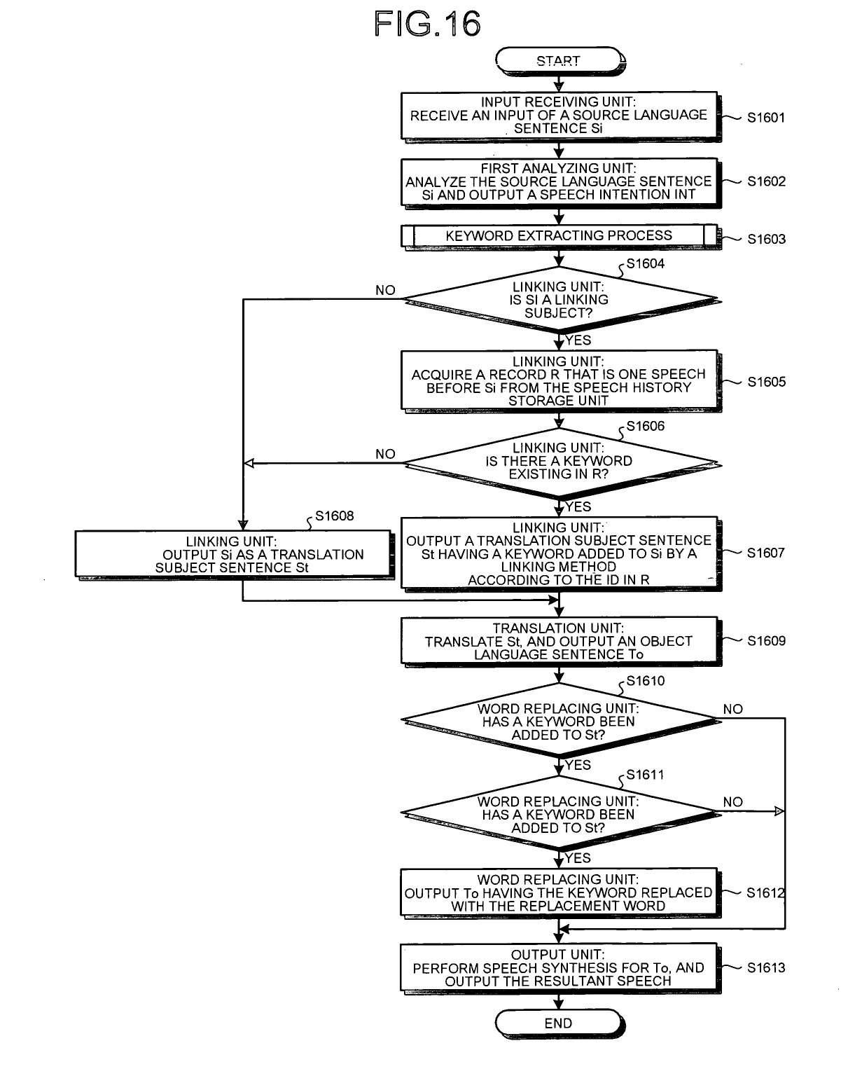

Next, a communication supporting operation to be performed by the communication supporting apparatus 1300 according to the second embodiment having the above described structure will be explained. FIG. 16 is a flowchart showing the entire flow of the communication supporting operation in accordance with the second embodiment.

First, the input receiving unit 101 receives an input of a source language sentence Si (step S1601). This procedure is the same as step S501 of the first embodiment.

The first analyzing unit 1307 then analyzes the source language sentence Si, and outputs a speech intention INT (step S1602). More specifically, the first analyzing unit 1307 refers to the past speeches stored in the speech history storage unit 1312 and the input source language sentence Si, and analyzes and outputs the speech intention of the source language sentence Si through natural language processing such as context analysis.

The extracting unit 102 then carries out a keyword extracting process (step S1603). The keyword extracting process of the second embodiment differs from the keyword extracting process of the first embodiment in that the speech intention INT is also stored in the speech history storage unit 1312 in step S606 at the same time. The other constitutions of the entire flow of the keyword extracting process are the same as those shown in the flowchart of the first embodiment in FIG. 6, and therefore, explanation of them is omitted herein.

The keyword adding unit 1303 then determines whether the source language sentence Si is a keyword adding subject (step S1604). For example, when “question” is acquired as the speech intention one speech before the latest speech from the speech history storage unit 1312 and the speech intention of the latest speech is “answer”, the speech intentions match the speech intention 1401 in the adding condition storage unit 1314 as shown in FIG. 14. Accordingly, the keyword adding unit 1303 acquires the corresponding adding process flag 1402 (Yes), and carries out an adding process. Thus, the source language sentence Si is determined to be a keyword adding subject.

If the source language sentence Si is a keyword adding subject (“YES” in step S1604), the keyword adding unit 1303 acquires the record R that is one speech before the latest speech (step S1605) from the speech history storage unit 1312. If the source language sentence Si is not a keyword adding subject (“NO” in step S1604), the keyword adding unit 1303 outputs the source language sentence Si as a translation subject sentence St (step S1608).

In this manner, it is possible to determine whether a keyword adding process should be carried out with the speech intention being taken into consideration. Accordingly, it is not necessary to consistently check a keyword, but a keyword can be confirmed in an effective timing. Thus, smooth communication supporting can be performed, without interrupting the flow of conversation.

The keyword adding process, the translating process, the word replacing process, and the output process of steps S1606 through S1613 are the same as the procedures of steps S504 through S511 carried out in the communication supporting apparatus 100 of the first embodiment, and therefore, explanation of them is omitted herein.

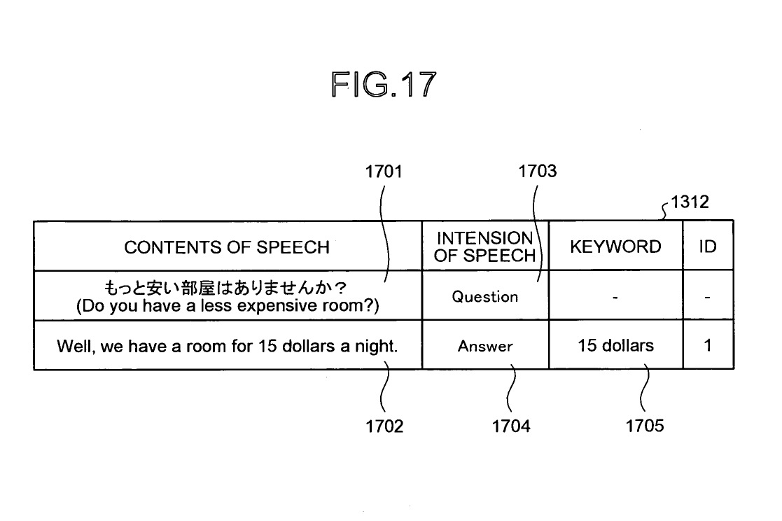

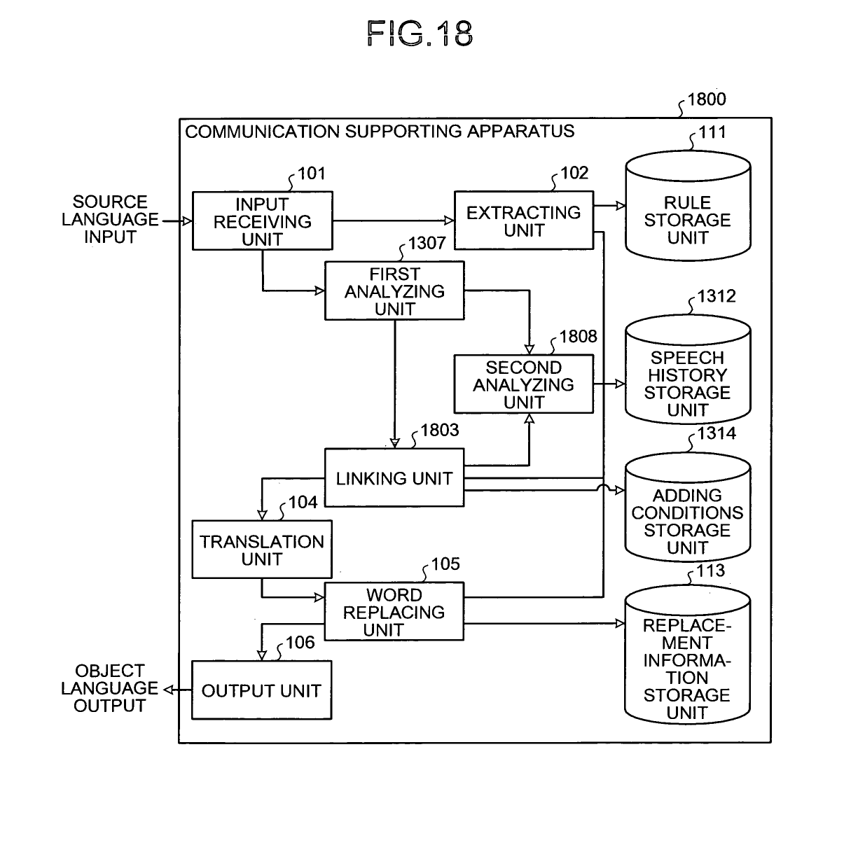

Next, a specific example of the communication supporting operation in accordance with the second embodiment is described. FIG. 17 is an explanatory view showing an example of the information to be stored in the speech history storage unit 1312.

It should be noted that the following explanation is made on the assumption that the information shown in FIG. 14 is stored in the adding condition storage unit 1314.

When the Japanese speaker speaks a Japanese sentence 1701 in this situation, the input receiving unit 101 receives an input of the Japanese sentence 1701 as a source language sentence Si (step S1602).

The first analyzing unit 1307 then analyzes the Japanese sentence 1701 to determine that the Japanese sentence 1701 has the speech intention of “question”, and outputs the analysis result (step S1602). The output speech intention (a speech intention 1703 in FIG. 17) is stored in the first analyzing unit 1307.

The keyword adding unit 1303 then refers to the speech history storage unit 1312 to determine whether the source language sentence Si is a keyword adding subject (step S1604). At this stage, only the Japanese sentence 1701 is stored in the speech history storage unit 1312. As for the speech intention of “question”, there is not a record in the adding condition storage unit 1314. Therefore, the keyword adding unit 1303 determines the source language sentence Si not to be a keyword adding subject (“NO” in step S1604).

When an English speaker speaks an English sentence 1702 “Well, we have a room for 15 dollars a night.” in response to the Japanese sentence 1701, the input receiving unit 101 receives an input of the English sentence 1702 as a source language sentence Si (step S1602).

The first analyzing unit 1307 then analyzes the English sentence 1702 to determine that the English sentence 1702 has the speech intention of “answer”, and outputs the analysis result (step S1602). The output speech intention (a speech intention 1704 in FIG. 17) is stored in the first analyzing unit 1307. In this case, a keyword 1705 shown in FIG. 17 is extracted as a keyword (step S605), and is stored in the first analyzing unit 1307 (step S606).

The keyword adding unit 1303 refers to the speech history storage unit 1312 to determine whether the source language sentence Si is a keyword adding subject (step S1604). At this stage, the Japanese sentence 1701 and the English sentence 1702 are stored in the speech history storage unit 1312, and the combination of the intentions of those two speeches is “question” and “answer”. This combination matches the speech intention 1401 in the adding condition storage unit 1314 in FIG. 14. Therefore, the source language sentence Si is determined to be a keyword adding subject (“YES” in step S1604).

Accordingly, the keyword adding unit 1303 carries out the procedures of steps S1605 through S1607, to perform a keyword searching process and an adding process.

In this manner, in the communication supporting apparatus 1300 of the second embodiment, a keyword adding process can be carried out only when the speech intention is analyzed and the analysis result of the speech intention matches a predetermined speech intention. For this reason, a keyword can be confirmed in an effective timing, and smooth communication supporting can be performed without interrupting the flow of conversation.

A communication supporting apparatus in accordance with a third embodiment of the present invention adds a modifier or a modificand including a keyword to an anaphoric expression in a speech and then outputs the resultant sentence, when an antecedent represented by the anaphoric expression in the speech is detected, and the modifier or the modificand of the antecedent contains the keyword.

FIG. 18 is a block diagram showing the structure of a communication supporting apparatus 1800 in accordance with the third embodiment. As shown in FIG. 18, the communication supporting apparatus 1800 includes an input receiving unit 101, a extracting unit 102, a keyword adding unit 1803, a translation unit 104, a word replacing unit 105, an output unit 106, a first analyzing unit 1307, a second analyzing unit 1808, a rule storage unit 111, a speech history storage unit 1312, a replacement information storage unit 113, and an adding condition storage unit 1314.

The third embodiment differs from the second embodiment in that the second analyzing unit 1808 is added, and the function of the keyword adding unit 1803 is different from that of the keyword adding unit 1303 of the second embodiment. The other aspects and functions of the third embodiment are the same as those of the communication supporting apparatus 1300 of the second embodiment shown in the block diagram of FIG. 13. The same components as those of the second embodiment are denoted by the same reference numerals as those of the second embodiment, and explanation of them is omitted herein.

The second analyzing unit 1808 refers to the past speeches stored in the speech history storage unit 1312, and performs an anaphora analyzing operation to detect that an expression such as a pronoun contained in a speech in a source language represents the same content or subject as an expression such as a noun phrase contained in the past speeches. An expression that represents another subject in a detected speech in the source language, such as a pronoun contained in the speech, is called an anaphoric expression. Further, the subject represented by the anaphoric expression is called an antecedent.

For example, when “This dress is a little bit large in size.” is input as a first speech followed by “I'll take it.” as a second speech, the second analyzing unit 1808 analyzes the antecedent for the anaphoric expression “it”, which is the pronoun in the second speech, and identifies the antecedent to be “dress” in the first speech.

The anaphora analyzing operation to be performed by the second analyzing unit 1808 can utilize various conventional methods, such as a technique of estimating the antecedent of a pronoun through context analysis based on a cache model or the centering theory.

When the second analyzing unit 1808 detects an anaphoric expression in an input source language sentence and the corresponding antecedent from the past speeches, and when the modificand or the modifier of the detected antecedent contains a keyword, the keyword adding unit 1803 outputs the input source language sentence having the anaphoric expression linked with the modificand or the modifier of the antecedent.

When an anaphoric expression and an antecedent are not detected, the operation to be performed is the same as the operation performed by the keyword adding unit 1303 according to the second embodiment.

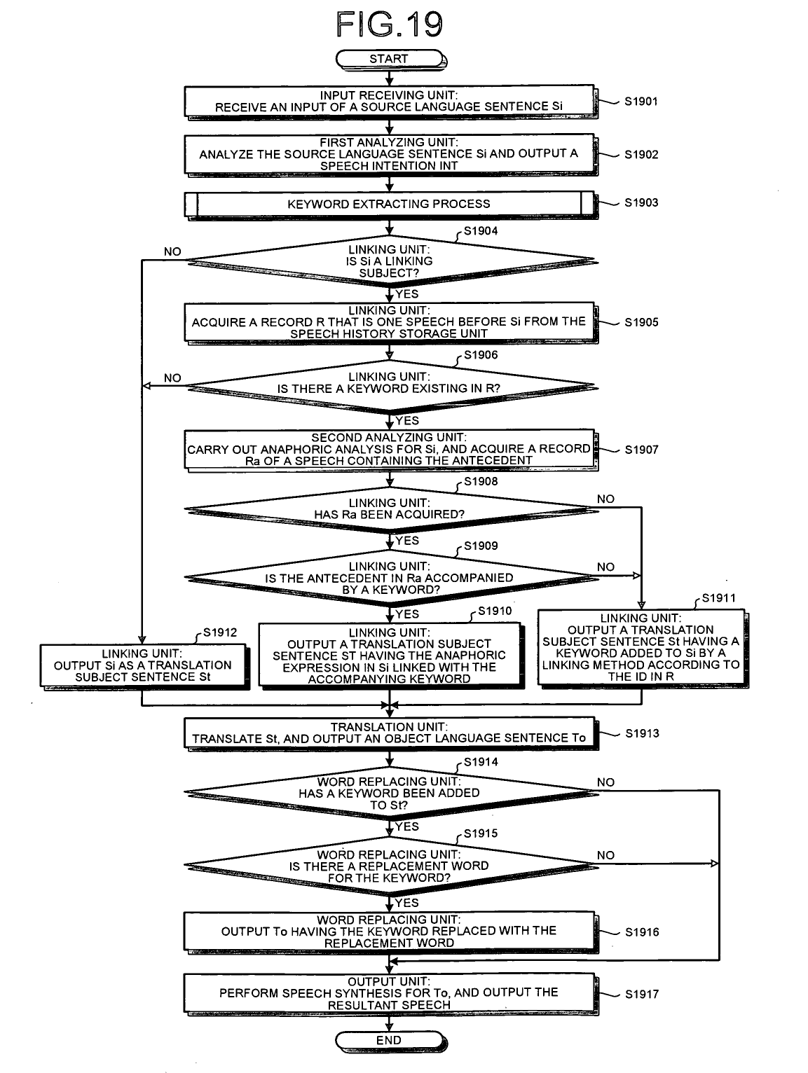

Next, a communication supporting operation to be performed by the communication supporting apparatus 1800 according to the third embodiment having the above described construction will be explained. FIG. 19 is a flowchart showing the entire flow of the communication supporting operation in accordance with the third embodiment.

The input receiving process, the speech intention analyzing process, the keyword extracting process, and the keyword existence confirming process of steps S1901 through S1906 are the same as those of steps S1601 through S1606 carried out in the communication supporting apparatus 1300 according to the second embodiment, and therefore, explanation of them is omitted herein.

When it is determined that a keyword exists in the record R that is one speech earlier than the source language sentence Si in step S1906 (“YES” in step S1906), the second analyzing unit 1808 carries out anaphora analysis for the source language sentence Si, and acquires a record Ra containing the antecedent from the speech history storage unit 1312 (step S1907).

The keyword adding unit 1803 then determines whether the record Ra has been acquired, that is whether the anaphoric expression and the corresponding antecedent have been detected (step S1908). If the keyword adding unit 1803 determines that the record Ra has been acquired (“YES” in step S1908), the keyword adding unit 1803 determines whether the antecedent contained in the record Ra is accompanied by a keyword (step S1909).

Here, the “antecedent being accompanied by a keyword” means that a keyword can be extracted from the modifier or the modificand of the antecedent. The keyword extraction is performed by referring to the rule storage unit 111 to search a matching extraction condition in the same manner as in the keyword extraction from a source language sentence.

When the antecedent is determined to be accompanied by a keyword in step S1909 (“YES” in step S1909), the keyword adding unit 1803 outputs a translation subject sentence St having the anaphoric expression in the source language sentence Si linked with the accompanying keyword (step S1910).

Here, the “accompanying keyword” is the modifier or the modificand containing the keyword. Also, the “anaphoric expression being linked with the accompanying keyword” means that the modifier containing the keyword is added so as to modify the anaphoric expression, or that the modificand containing the keyword is added so as to be modified by the anaphoric expression.

The keyword adding process, the translating process, the word replacing process, and the output process of steps S1911 through S1917 are the same as those of steps S1607 through S1613 carried out in the communication supporting apparatus 1300 according to the second embodiment, and therefore, explanation of them is omitted herein.

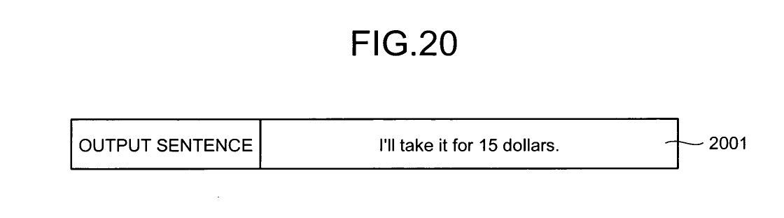

Next, a specific example of the communication supporting operation in accordance with the third embodiment is described. FIG. 20 is an explanatory view showing an example of an output sentence to be output by the communication supporting apparatus 1800.

The following explanation is made on the assumption that the Japanese sentence 701 meaning “Do you have a less expensive room?” spoken by a Japanese speaker and the English sentence 702 spoken by an English speaker as shown in FIG. 7 have already been input, and the speech history storage unit 1312 holds the record shown in FIG. 8. Also, the information shown in FIG. 2 and the information shown in FIG. 4 are stored in the rule storage unit 111 and the replacement information storage unit 113, respectively.

When the Japanese speaker speaks the Japanese sentence 703 meaning “I'll take it.” in this situation, the input receiving unit 101 receives an input of the Japanese sentence 703 as a source language sentence Si.

Here, it is assumed that the input receiving unit 101 recognizes the input speech correctly and outputs the input speech as the source language sentence Si (step S1901), and the first analyzing unit 1307 determines the intention of the speech is “acceptance” (step S1902).

The keyword extracting process is then carried out (step S1903). Since there is not a matching extraction condition (“NO” in step S604), only the source language sentence Si is stored in the speech history storage unit 1312 (step S606).

Next, whether the source language sentence Si is a keyword adding subject is determined based on the relationship between the speech intentions (step S1904). Since the speech intention one speech before the input speech is “answer” and the speech intention of the input speech is “acceptance”, the matching condition of speech intentions exists in FIG. 14, and therefore the source language sentence Si is determined to be a keyword adding subject (“YES” in step S1904).

The keyword adding unit 1803 then refers to the speech history storage unit 1312, and acquires the record R corresponding to the speech content 802 “Well, we have a room for 15 dollars a night.” as the record one speech before the source language sentence Si (step S1905). Since the acquired record R contains a keyword (“YES” in step S1906), the second analyzing unit 1808 carries out an anaphora analyzing process. Through this process, the anaphoric expression in Japanese meaning “it” is detected from the source language sentence Si, and the word “room” is acquired as the corresponding antecedent from the speech content 802 shown in FIG. 8. In this manner, the record corresponding to the speech content 802 is acquired as a record Ra (step S1907).

Since the record Ra is acquired (“YES” in step S1908), the keyword adding unit 1803 determines whether the antecedent “room” contained in the record Ra is accompanied by a keyword (step S1909). In this case, the antecedent “room” is accompanied by a modifier “for 15 dollars”. Because “15 dollars” is a money-related expression, it is also a keyword. Accordingly, the antecedent is determined to be accompanied by a keyword (“YES” in step S1909).

The keyword adding unit 1803 then outputs a translation subject sentence St having the anaphoric expression in the source language sentence Si linked with the modifier (step S1910). In this example, the translation subject sentence St having the Japanese anaphoric expression meaning “it” linked with the modifier “for 15 dollars” is output.

The translation unit 104 then translates the translation subject sentence St, to output an object language sentence To (step S1913).

Since the keyword is added to the translation subject sentence St (“YES” in step S1914), a replacement word searching process is carried out (step S1915). Since the corresponding keyword does not exist in the replacement information storage unit 113 shown in FIG. 4 (“NO” in step S1915), the output unit 106 performs speech synthesis for the object language sentence To, and outputs the resultant speech (step S1917). As a result, the source language sentence Si is translated, and an output sentence 2001 “I'll take it for 15 dollars.” shown in FIG. 20 is output as an English sentence having the keyword added thereto.

Through the above described procedures, the translation result of the essential part (“15 dollars”) can be added to the translation result of the speech of the Japanese speaker and the resultant sentence is output, even if the essential part is mistakenly recognized as in the case where the English sentence “Well, we have a room for 50 dollars a night.” spoken by the English speaker is recognized as “Well, we have a room for 15 dollars a night.”

In this manner, the communication supporting apparatus 1800 according to the third embodiment identifies the antecedent represented by the anaphoric expression in the speech. When the modifier or the modificand of the antecedent contains a keyword, the modifier or the modificand containing the keyword is added to the anaphoric expression in the speech, and the resultant sentence can be output. Therefore, when the antecedent is accompanied by a keyword as a modifier or a modificand, the keyword can be properly added to the anaphoric expression corresponding to the antecedent.

Each of the communication supporting apparatuses according to the first to third embodiments includes a control device such as a CPU (Central Processing Unit), a storage device such as a ROM (Read Only Memory) or a RAM (Random Access Memory), an external storage device such as a HDD (Hard Disk Drive), a CD (Compact Disc) or a drive device, a display device such as a display screen, and an input device such as a keyboard and a mouse. This is a hardware constitution that utilizes a general computer.

The communication supporting program to be executed in each of the communication supporting apparatuses according to the first to third embodiments is stored beforehand in a ROM (Read Only Memory) or the like.

The communication supporting program to be executed in each of the communication supporting apparatuses according to the first to third embodiments may be recorded in an installable or executable file format on a computer-readable recording medium such as a CD-ROM (Compact Disk Read Only Memory), a flexible disk (FD), a CD-R (Compact Disk Recordable), or a DVD (Digital Versatile Disk).

The communication supporting program to be executed in each of the communication supporting apparatuses according to the first to third embodiments may also be stored in a computer that is connected to a network such as the Internet, and may be downloaded via the network. The communication supporting program to be executed in each of the communication supporting apparatuses according to the first to third embodiments may also be provided or distributed via a network such as the Internet.

The communication supporting program to be executed in each of the communication supporting apparatuses according to the first to third embodiments has a module configuration that includes the functions of the above described components (an input receiving unit, a extracting unit, a linking unit, a translation unit, a word replacing unit, an output unit, a first analyzing unit, and a second analyzing unit). As the actual hardware, the CPU (Central Processing Unit) reads the communication supporting program from the ROM and executes the program, so that the above described components are loaded and generated in the main storage device.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A communication supporting apparatus comprising:
a rule storage unit that stores an extraction condition and a linking procedure linked with the extraction condition;
an input receiving unit that receives a first speech in a first language and a second speech in a second language;
an extracting unit that extracts a keyword from the first speech based on the extraction condition stored in the rule storage unit;
a translation unit that translates the first speech from the first language into the second language;
an output unit that outputs the translated first speech in the second language; and
a linking unit that links the keyword extracted by the extracting unit with the second speech, wherein
the input receiving unit receives the second speech spoken immediately after outputting of the translated first speech,
the linking unit links the extracted keyword with the second speech based on the linking procedure that is utilized for outputting the extracted keyword linked with the second speech in the second language spoken after the first speech in the first language, and corresponds to the extraction condition,
the translation unit further translates the second speech linked with the extracted keyword from the second language into the first language, and
the output unit further outputs the extracted keyword in the first language linked with the second speech, and the translated second speech.

2. The communication supporting apparatus according to claim 1, wherein
the rule storage unit stores the extraction condition for extracting a predetermined search subject word as a keyword from a speech and the linking procedure being correspond to the extraction condition, the linking procedure being utilized for outputting a phrase having the extracted keyword put in a predetermined position in the phrase, the phrase being linked with a speech spoken after the speech from which the keyword is extracted;
the extracting unit extracts the same word as the search subject word or a similar word to the search subject word as the keyword from the first speech, based on the extraction condition stored in the rule storage unit; and
the linking unit links the second speech with the phrase having the extracted keyword put in the predetermined position in the phrase, based on the linking procedure made to correspond to the extraction condition used when the keyword is extracted.

3. The communication supporting apparatus according to claim 1, wherein
the rule storage unit stores the extraction condition for extracting a word corresponding to an example keyword as a keyword from a speech and the linking procedure linked with the extraction condition, where the example keyword is a predetermined keyword contained in an example sentence of a predetermined speech, the extraction condition is utilized for outputting a phrase having the extracted keyword put in a predetermined position in the phrase, and the phrase is linked with a speech spoken after the speech from which the keyword is extracted;
the extracting unit searches the example sentence that is the same as or similar to the first speech from the rule storage unit, and extracts a word corresponding to the example keyword contained in the detected example sentence, where the word is extracted as the keyword from words contained in the first speech, based on the extraction condition stored in the rule storage unit; and
the linking unit links the second speech with the phrase having the extracted keyword put in the predetermined position in the phrase, based on the linking procedure made to correspond to the extraction condition used when the keyword is extracted.

4. The communication supporting apparatus according to claim 1 further comprising:
a speech history storage unit that stores a speech history of the first speech and the second speech; and
a first analyzing unit that analyzes a speech intention of the second speech based on the speech history stored in the speech history storage unit and the second speech, wherein
the linking unit links the second speech with the extracted keyword based on the linking procedure made to correspond to the extraction condition used for extracting the keyword, when the speech intention of the second speech matches a predetermined speech intention.

5. The communication supporting apparatus according to claim 1 further comprising:
a second analyzing unit that analyzes a meaning of the second speech, and acquires a subject indicated by an anaphoric expression representing another subject contained in a speech in the second speech from the speech history stored in the speech history storage unit, wherein
the linking unit links the anaphoric expression contained in the second speech with a modificand or a modifier of the indicated subject, when the modificand or the modifier of the indicated subject contains the extracted keyword.

6. The communication supporting apparatus according to claim 1 further comprising:
a replacement information storage unit that stores an arbitrary word and a replacement word linked with the arbitrary word, where the replacement word has the same meaning as the arbitrary word but is expressed in a different form from the arbitrary word; and
a word replacing unit that searches the replacement word corresponding to the keyword linked with the translated second speech from the replacement information storage unit, and replaces the keyword linked with the translated second speech with the searched replacement word, wherein
the output unit outputs the translated first speech, the replacement word in place of the keyword, and the translated second speech.

7. The communication supporting apparatus according to claim 1 further comprising:
a speech recognizing unit that receives audio inputs of the first speech and the second speech, and outputs a speech recognition result after recognizing the received speeches, wherein
the input receiving unit receives the speech recognition result output by the speech recognizing unit as the input of the first speech or the second speech.

8. The communication supporting apparatus according to claim 1 further comprising:
a character recognizing unit that receives inputs of the first speech and the second speech in the form of character information, and outputs a character recognition result after recognizing the received character information, wherein
the input receiving unit receives the character recognition result output by the character recognizing unit as the inputs of the first speech and the second speech.

9. The communication supporting apparatus according to claim 1 further comprising:
a displaying unit that displays the second speech, wherein
the output unit outputs the translated second speech to the displaying unit.

10. The communication supporting apparatus according to claim 1, wherein the output unit outputs the translated second speech to a printer.

11. The communication supporting apparatus according to claim 1 further comprising:
a speech synthesizing unit that performs speech synthesis in the second language for the translated second speech, wherein
the output unit outputs the synthesized speech in the second language.

12. The communication supporting apparatus according to claim 11, wherein the speech synthesizing unit performs speech synthesis by changing the sound attributes including the volume and quality of the sound corresponding to a keyword contained in the translated second speech, to different sound attributes from sound attributes corresponding to other than the keyword contained in the translated second speech.

13. A communication method comprising:
receiving a first speech in a first language;
extracting a keyword from the first speech in the first language, based on an extraction condition;
translating the first speech from the first language into a second language;
outputting the translated first speech in the second language;
receiving a second speech in the second language, immediately after outputting of the translated first speech in the second language;
linking the second speech in the second language, with the extracted keyword in the first language based on a linking procedure correspond to the extraction condition, the linking procedure being utilized for outputting the extracted keyword linked with the second speech in the second language spoken after the first speech in the first language;
translating the second speech from the second language into the first language; and
outputting the extracted keyword in the first language linked with the second speech, and the translated second speech.

14. A computer program product having a computer readable medium including programmed instructions for processing communication supporting, wherein the instructions, when executed by a computer, cause the computer to perform:
receiving a first speech in a first language;
extracting a keyword from the first speech in the first language, based on an extraction condition;
translating the first speech from the first language into a second language;
outputting the translated first speech in the second language;
receiving a second speech in the second language, immediately after outputting of the translated first speech in the second language;
linking the second speech in the second language, with the extracted keyword in the first language based on a linking procedure correspond to the extraction condition, the linking procedure being utilized for outputting the extracted keyword linked with the second speech in the second language spoken after the first speech in the first language;
translating the second speech from the second language into the first language; and
outputting the extracted keyword in the first language linked with the second speech, and the translated second speech.
